(19) United States
(12) Patent Application Publication
(10) Pub. No.: US 2012/0063838 A1
(43) Pub. Date: Mar. 15, 2012

(54) DOCKING MECHANISM FOR PATIENT TABLES

(76) Inventors: Rajeev Sahu, Bangalore (IN); Sale Gangi Venkata Prasad, Bangalore (IN); Kanjimpuredathil Muralikrishna Menon, Palakkad District (IN)

(21) Appl. No.: 13/233,561

(22) Filed: Sep. 15, 2011

(30) Foreign Application Priority Data
Sep. 15, 2010 (IN) 2708/CHE/2010

(51) Int. Cl. A61G 13/10; F16B 5/00

(52) U.S. Cl. 403/24; 403/322.4

(57) ABSTRACT

A docking mechanism attachable to a first table capable of docking the first table with a second table through at least one locking feature associated with the second table is disclosed herein. The mechanism comprises: a tapering receiving chamber having a locking groove for receiving the locking feature from the second table and a lock lever located adjacent to the locking groove, the lock lever being moved to dock the tables. A link lever is attached to a lock lever, the link lever being rotated through the lock lever to dock the locking feature with the locking groove. A gearing assembly is provided in association with the receiving chamber having a first gearing unit linked with a second gearing unit, the first gearing unit being connected to the link lever. The link lever rotates without rotating the first gearing unit while docking the tables and the lock lever rotates through the first and second gearing unit to undock the patient tables.

### FIELD OF INVENTION

This invention relates generally to a docking mechanisms and more particularly to, a docking mechanism for automatically docking two patient tables for transporting patient from one table to another.

### BACKGROUND OF INVENTION

During a surgical procedure or after the surgery, patient needs to be moved from one table to another. There are simple transfer boards associated with various patient tables to enable a seamless transfer of patient between one table to another without physically picking or repositioning. The patient tables need to be docked properly to facilitate the smooth transfer.

Currently, patients and objects can be imaged using a wide variety of different imaging technologies. Such imaging technologies can include magnetic resonance imaging (MRI), computer tomography (CT), X-ray imaging, and others. Each imaging technology has unique advantages and disadvantages in imaging certain types of physiological or physical characteristics. Plurality of imaging techniques may be used in sequence for diagnostics.

In some imaging applications, multiple imaging modalities are desirable. During interventional procedures, X-ray imaging is preferred because of the easy access doctors have to the patient for guide wire and catheter manipulation. However, to obtain the improved soft tissue contrast and three-dimensional imaging of MRI, MRI images are required. In particular, X-ray imaging can be used to guide invasive devices and MRI can monitor the results of the therapy in the surrounding tissues. When combining X-ray imaging and MRI technologies in the interventional environment, there is a need for quickly moving the patient between the X-ray system and the MR system without excessive anatomical movement and disruption of the patient. Thus there are various instances wherein patient needs to be transferred quickly from one table to another without much physical movement of the patient. This is achieved by docking the patient tables and transferring the patient from one table to another using transfer board or similar mechanisms.

In some of the clinical applications, diagnostics methods or data collection methods need to be performed during interventional procedures. For this, patient needs to be transferred from surgery room to Magnetic resonance (MR) room for data collection. In an example, a surgical table is provided with mechanism to enable MR data collection during interventional procedures. The surgical tables are provided with simple transfer boards to enables a seamless transfer of patient from surgical table to a patient table without physically picking or repositioning. The surgical table is provided with a docking mechanism to align and lock the surgical table to the patient table such that there is no relative motion between them while transferring the patient from one table to another. Docking mechanisms are very important as failure of docking may create hazardous situation and can cause excessive anatomical movement and disruption of the patient.

In the existing surgical tables, docking and undocking are done manually, which requires two people to complete the docking process of the tables. One has to push surgical table and another to lock the tables together. Further the patient table has to be perfectly aligned with the surgical table to dock them and if the alignment is not proper, it may not be docked properly. Further the locking status is determined manually and error in determining the same could create a hazardous situation.

Thus there exist a need for an improved patient transport system and method, which allows quick transfer of a patient in a straight-line motion between imaging modalities. Accordingly, there is a need for an improved patient table docking mechanism capable of docking patent tables automatically.

### SUMMARY OF INVENTION

The above-mentioned shortcomings, disadvantages and problems are addressed herein which will be understood by reading and understanding the following specification.

One embodiment of the present invention provides a docking mechanism attachable to a first table capable of docking the first table with a second table through at least one locking feature associated with the second table is disclosed. The mechanism comprises; a tapering receiving chamber having a locking groove for receiving the locking feature from the second table; a lock lever located adjacent to the locking groove, the lock lever being moved to dock the tables; a link lever attached to a lock lever, the link lever being rotated through the lock lever to dock the locking feature with the locking groove; a gearing assembly associated with the receiving chamber having a first gearing unit linked with a second gearing unit; first gearing unit being connected to the link lever; wherein the link lever rotates without rotating the first gearing unit while docking the tables and the lock lever rotates through the first and second gearing unit to undock the patient tables.

In another embodiment, a patient transport system for transferring patient from a first table to a second table is disclosed. The system comprises: a docking assembly having at least two docking mechanisms connected via a shaft, each docking mechanism comprises a front portion and a rear portion, wherein the rear portion being attachable to the first table and the front portion capable of being receiving a locking feature from the second table; the front portion of each docking mechanism comprises: a tapering receiving chamber having a locking groove capable of receiving locking feature from the second table; a lock lever placed adjacent to the locking groove, the lock lever being moved to dock the tables; gearing assembly associated with the receiving chamber having a first gearing unit linked with a second gearing unit; first gearing unit being attached to the link lever; a second gearing unit attached to the shaft; a link lever attached to a lock lever; the link level connecting the lock lever to the gearing assembly wherein the link lever rotates without rotating the first gearing unit while docking the tables and lock lever being rotated through the second and first gearing unit to unlock the patient tables.

In yet another embodiment, a patient transfer mechanism from a manual patient table to a surgical patient table is described. The mechanism comprises: the manual table having at least two locking pins for locking the manual table with the surgical table; the surgical table having a docking assembly attached to one end of the table, the docking assembly comprises: a docking assembly having at least two docking mechanisms connected via a shaft, each docking mechanism comprises: a tapering receiving chamber having a locking groove capable of receiving locking pins from the manual table; a lock lever placed adjacent to the locking groove, the lock lever being moved to dock the tables; a link level attached to a lock lever, the link level being rotated through the lock lever to dock the locking feature with the locking groove; gearing assembly associated with the receiving chamber having a first gearing unit linked with a second gearing unit; first gearing unit being attached to the link lever; a second gearing unit attached to the shaft; wherein the docking assembly attached to the surgical table is configured to receive the locking pins from the manual table and automatically locks the pins to the locking groove and releases the locking pins upon manually rotating the knob.

Various other features, objects, and advantages of the invention will be made apparent to those skilled in the art from the accompanying drawings and detailed description thereof.

### BRIEF DESCRIPTION OF THE DRAWINGS

FIG. 1 shows position of a docking assembly as described in various embodiments of the invention;

FIG. 2 shows a surgical table connected with a docking assembly described in various embodiments of the invention;

FIG. 3 shows front view of docking assembly described in an embodiment of the invention;

FIG. 4 shows an embodiment of the lock lever used in the docking assembly as described in various embodiments of the invention;

FIG. 5 shows side view of the docking assembly as described in various embodiments of the invention;

FIG. 6 shows the locking feature engaged in the locking groove of the docking assembly described in various embodiments of the invention; and

FIG. 7 shows side view of the docking assembly indicating the lock lever position in the docked and/or undocked state and in the docking or undocking state as described in various embodiments of the invention.

### DETAILED DESCRIPTION OF INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention. To the extent that the figures illustrate diagrams of the functional blocks of various embodiments, the functional blocks are not necessarily indicative of the division between hardware circuitry. Thus, for example, one or more of the functional blocks may be implemented in a single piece of hardware. It should be understood that the various embodiments are not limited to the arrangements and instrumentality shown in the drawings.

Embodiments of the present invention provide a docking assembly for docking patient tables. The docking assembly is attached to a table and is capable of accommodating locking feature 309 from the other table. Single person can perform docking by pushing the roughly aligned table to the docking assembly. The tables can be undocked manually from both sides of the table. In an embodiment, the docking mechanism is used with surgical table or diagnostic patient tables.

Though the invention is explained with reference to patient tables, especially docking surgical tables with patient tables, the application of the docking assembly need not be limited to patient table. The proposed docking assembly could be used for any two mechanical structures that are roughly aligned and needs to be docked.

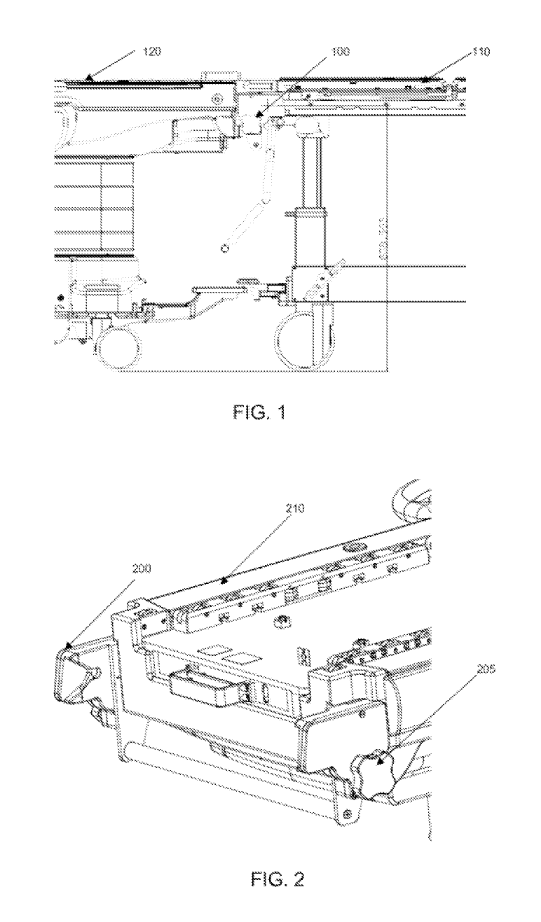

FIG. 1 shows position of a docking assembly as described in various embodiments of the invention. In an embodiment shown, the docking assembly 100 is fixed with surgical table 110. The surgical table 110 needs to be docked with a patient table 120, wherein the patient table 120 is provided with locking feature 309 such as engaging pins (shown in FIG. 6). The docking assembly 100 is attached to the surgical table 110 using screw mechanisms or any other fixing mechanisms such as pin joint. Plurality of fixing slots or screw slots is provided on one end of the surgical table 110 and/or on the docking assembly 100 to attach the docking assembly 100 to the surgical table 110. Fixing slots are provided on both sides of the surgical table 110, wherein at least one docking mechanism is attached to each side of the surgical table 110. The docking mechanism connected on each side of the surgical table 110 is connected together via a rotatable shaft and the docking mechanisms together with the rotatable shaft form the docking assembly 100. The surgical table 110 and the docking assembly 100 are provided with plurality of fixing slots to adjust the height and length of the docking assembly 100. In an embodiment, ±10 mm height and length can be adjusted using appropriate fixing slots. This will help for the initial alignment of the surgical table 110 with the patient table 120. The proper fixing slot needs to be identified before attaching the docking assembly 100 to the surgical table 110. Though the docking assembly 100 is shown as attached to the surgical table 110, the docking assembly 100 can be attached to the patent table 120 as well. In that event, the locking feature 309 will be part of the surgical table 110.

In an embodiment shown, the docking assembly is having two docking mechanisms, each docking mechanism attached to each side of the surgical table 110. However, docking assembly 100 can have only one docking mechanism, which may be attached to one side or at the center of the surgical table 110 based on the requirement and structure of the surgical table 110.

FIG. 2 shows a surgical table 210 connected with a docking assembly 200 as described in various embodiments of the invention. The docking assembly 200 is attached to one end of the surgical table 210. The docking assembly 200 shown has two docking mechanisms 205, each docking mechanism 205 is attached to each side of the surgical table 210. The docking mechanisms 205 are attached to the surgical table 210 using screw mechanism (not shown). The embodiment shown suggests using two docking mechanisms 205 connected via a rotating shaft (not shown) as the docking assembly 200. Usage of the docking assembly 200 shown in the embodiment will ensure that the docking can be achieved by pushing the table that needs to be docked to the docking assembly 200 and can be unlocked from both sides of the surgical table 210.

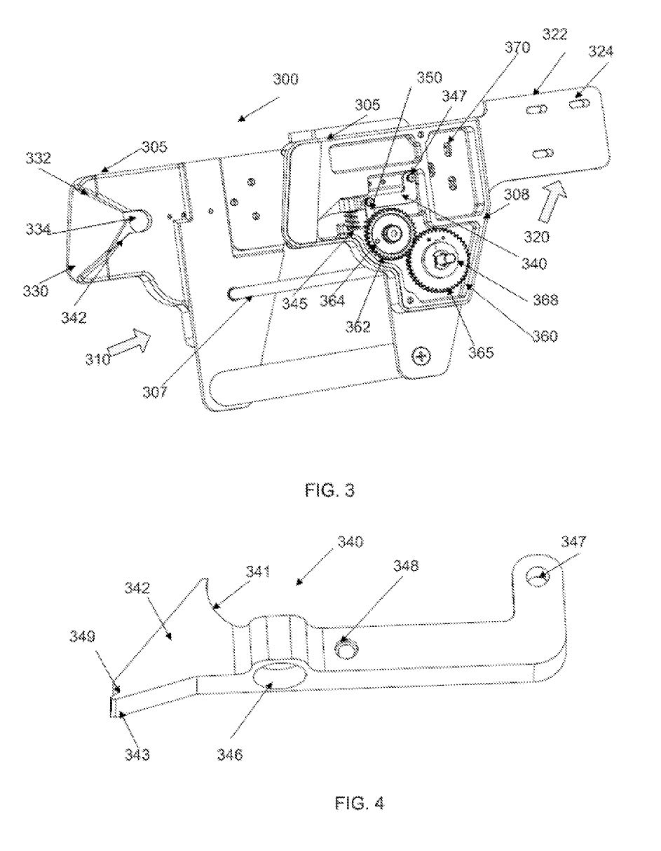

FIG. 3 shows front view of a docking assembly described in an embodiment of the invention. The docking assembly 300 could be used to dock two tables, one table is attached with the docking assembly 300 and other table is provided with a locking feature 309 that will be engaged with the docking assembly 300 while docking the tables. The docking assembly 300 is shown with two docking mechanisms 305 connected by a rotating shaft 307. The docking assembly 300 has a front portion 310 and rear portion 320. The rear portion 320 comprises a flank 322 with fixing slots 324. The rear portion 320 assists in attaching the docking mechanism 305 to the table. The fixing slots 324 may be used for initial alignment of the tables and/or a table with the docking mechanism 305.

Each docking mechanism 305 comprises a tapering receiving chamber 330, wherein the locking feature 309 from the table (not shown) that needs to be docked is received. The receiving chamber 330 has at least one tapering wall 332 tapering to form a locking groove 334. In the embodiment shown, there are two tapering walls 332 tapering towards one end to form a C shaped locking groove 334. The locking groove 334 is capable of receiving and holding the locking feature 309 while docking the tables. The locking feature 309 from each side of the table is received in the widest portion of the receiving chamber 330 and can be easily guided by the tapering wall 332 of the receiving chamber 330 to the locking groove 334. Thus the tapering shaped receiving chamber 330 assists in easy guiding of the locking feature 309 and docking the same. However the structure of the receiving mechanism may be designed based on various applications and structure of the docking tables.

The docking mechanism 305 comprises a lock lever 340 connected to a gear assembly 360 through a link lever 350. The portion of the lock lever extending to the receiving chamber 330 is called latch 342. The latch 342 will acts a door to facilitate the entry and exit of the locking feature 309 to the locking groove 334. The locking lever 340, specifically the latch 342 is located at the entrance of the locking groove 334. While engaging the locking feature 309 to the locking groove 334 the latch 342 moves down, thereby pushing the lock lever 340 and link lever 350 downwards.

The lock lever 340 is hinged to the housing 308 of the docking assembly 305, through a spring mechanism 345. While engaging the locking feature 309 with the locking groove 334, the latch 342 will be pushed down by the pressure applied by the locking feature. However once the locking feature 309 is engaged with the locking groove 334, the pressure on the lock lever is reduced and due to which the spring mechanism 345 releases, positioning the lock lever 340 and link lever 350 to its original position.

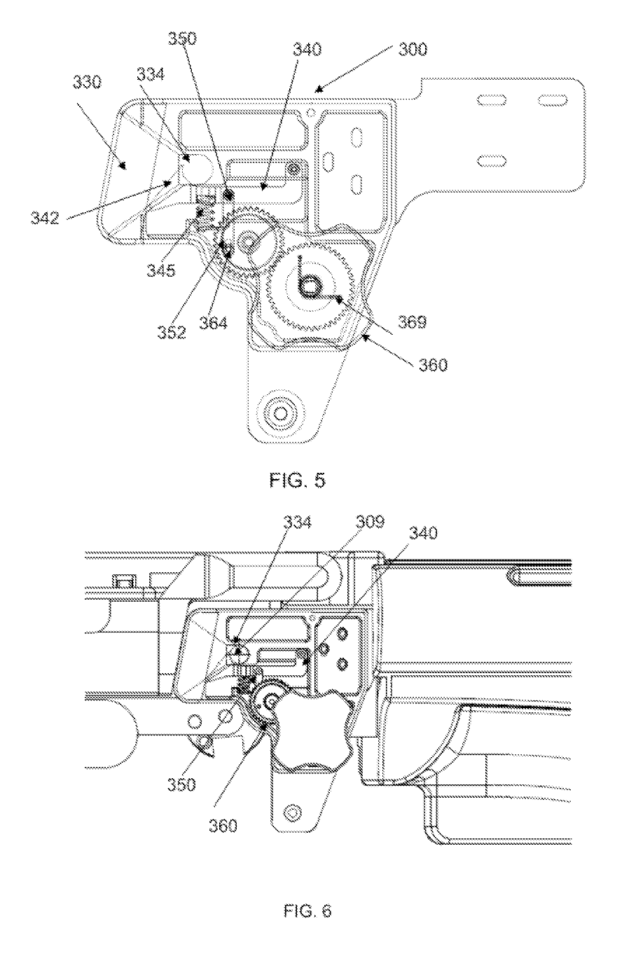

The lock lever 340 is connected to the link lever 350. When the lock lever 340 moves downwards, it pushes the link lever 350 also downwards. The link lever 350 is connected to a first gearing unit 362 in the gearing assembly 360. The link lever 350 is connected through a gear pin 364 to the first gear unit 362. A gear slot 352 (shown in FIG. 5) is provided on the link lever 350 to accommodate the gear pin 364. The gear slot 352 is big enough to accommodate the gear pin 364 even when the link lever 350 is moving. Due to the gear slot 352 in the link lever 350, the link lever 350 moves freely without any movement to the first gearing unit 362. The movement of the link lever 350 will be vertical with reference to the gear pin 364, while docking the locking feature. Since the movement is vertical only, the movement of the link lever 350 will not rotate the first gearing unit 362. Thus while engaging the locking feature 309 or while docking the tables, the locking feature 309 pushes the lock lever 340 downwards, there by pushing the link lever 350 downwards. Because of the gear slot 352 provided on the link lever 350, the link lever 350 moves downwards with reference to the gear pin 364 without rotating the first gearing unit 362. Once the lock lever 340 retains its original position due to spring mechanism 345, the link lever 350 also moves upwards to its original position, without rotating the first gearing unit 362.

The gearing assembly 360 has the first gearing unit 362 and a second gearing unit 365. The gearing assembly 360 of one docking mechanism 305 is connected with other docking mechanism via a rotating shaft 307. Each end of the rotating shaft 307 is provided with a knob 368 to rotate the second gearing unit 365 for undocking the tables. Once the rotating knob 368 is rotated, the second gearing unit 365 rotates; which rotates the first gearing unit 362 as well. Once the first gearing unit 362 rotates, the link lever 350 connected with the first gearing unit 362 also rotates and the lock lever 340 moves down there by releasing the locking feature 309 from the locking grove 334. When the first gearing unit 362 moves, the link lever 350 move down, and this causes the lock lever 340 to move down with respect to a lock lever point 347. The lock lever 340 is provided with a lock lever point 347 and the lock lever 340 moves with reference to the lock lever point 347. Once the lock lever 340 moves down, the latch 342 also moves down there by releasing the locking feature 309 from the locking groove 334.

The flank 322 in the rear portion 320 is attached with the front portion 310 using screw mechanism 370 or any other fixing mechanism such as pint joint. Alternately the docking mechanism 305 could be constructed as single unit.

The rotating shaft 307 is configured to transfer motion from one docking mechanism 305 to another, thereby facilitating undocking of the tables from both sides. Each second gearing unit 365 is provided with a torsion spring 369 (shown in FIG. 5) to retain its original position. Once the locking feature 309 is released, the torsion spring 369 gets released and the second gearing unit 365 rotates to its original position, thereby rotating the knob 368 to its original position. Once the locking feature 309 is released, the lock lever 340 retains its original position due to spring mechanism 345, thereby moving the link lever 350 as well to its original position. Thus in the ideal sate the docking mechanism 305 will be in the locked stated i.e the latch 342 in the upward position.

In the proposed docking assembly, the default condition of the lock lever 340 is closed. The lock lever 340 is able to accept and lock the locking feature 309 and this is not position dependant of the lock lever 340. The rotating knob 368 of the table does not rotate while docking and after undocking it reach again in the default condition.

In an embodiment, the docking assembly 300 is provided with a docking status-indicating mechanism. A detent is provided on the rotating knob 368 with a chamfered hole on the housing of the docking mechanism and the rotating knob 368 to indicate the locking status.

FIG. 4 shows an embodiment of the lock lever used in the docking assembly as described in various embodiments of the invention. The lock lever 340 is provided with a latch 342 at one end, the latch 342 extends into the receiving chamber 330 of the docking mechanism 305 shown in FIG. 3. The latch 342 is curved shaped at one end to align with the locking grove 334 in the receiving chamber 330. The lock lever 340 is provided with a bore 346 to accommodate the spring mechanism 345. Further the lock lever 340 is provided with a link slot 348 to accommodate the link lever 350. The link lever 350 could be attached to the lock lever 340 using a pin joint. The lock lever 340 is attached to the housing of the docking assembly 308 through a lock lever point 347 using a pin joint. The lock lever 340 moves and/or rotates with reference to the lock lever point 347. The latch 342 has a first end 341, which are curve shaped, extending into the receiving chamber and a second end 343 extending into the housing of the docking assembly 308 provided. The second end 343 is provided with a housing slot 349 and corresponding to the housing slot 349, a stopper is provided on the housing of the docking assembly 308. The stopper provided on the housing of the docking assembly 308 along with the housing slot 349 on the lock lever 340 will ensure proper placing of the latch 342 on the receiving chamber 330.

FIG. 5 shows side view of the docking assembly as described in various embodiments of the invention. The dotted line of the latch 342 indicates the position of the lock lever 340 before and after locking the locking feature 309 to the locking groove 334, indicating the docked and undocked state. The link lever 350 is connected through a gear pin 364 to the gearing assembly 360. A gear slot 352 is provided on the link lever 350 to accommodate the gear pin 364. The undocking state the gear pin 364 will be moving in accordance with the gearing unit 360 movement and thus the gear pin 364 is positioned towards the lower end of the gear slot 352. Towards the end of the docking state, the gear pin 364 will be positioned towards the upper end of the gear slot 352. While docking, the gear pin 364 will not be moving and the lock lever 340 moves to position the gear pin 364 towards toe upper end of the gear slot 352. The spring mechanism 345 associated with the lock lever 340 is in compressed mode, indicating the downward position of the lock lever 340 while docking and/or undocking.

The gearing assembly 360 does not move its position in the docked/undocked and docking state. The gearing assembly 360 will be rotating only while undocking the locking feature. The torsion spring 369 associated with the second gearing unit 365 is shown, which assists the gearing assembly 360 to retain its original position, once tables are undocked.

FIG. 6 shows the locking feature engaged in the locking groove of the docking assembly described in various embodiments of the invention. The locking feature 309 is a pin, which is placed within the locking groove 334. The latch lever 340 and link lever 350 and the gearing assembly 360 are positioned in its locked state or the default position.

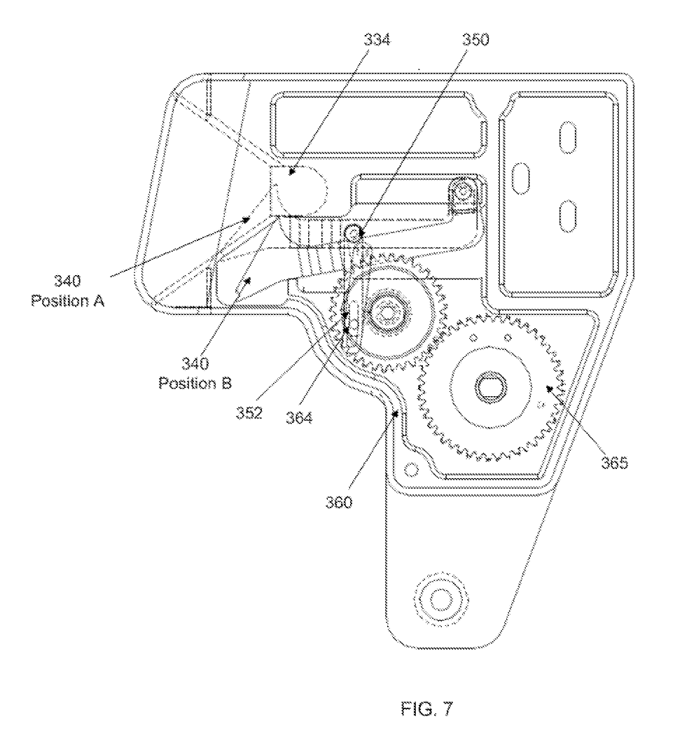

FIG. 7 shows side view of the docking assembly indicating the lock lever position in the docked and undocked state as described in various embodiments of the invention. The latch lever 340 indicated by dotted lines indicates the position of the lock lever 340 before and after locking the locking feature 309 (not shown) to the locking groove 334, referred as position A, indicating the docked and undocked state. The lock lever 340 indicated by solid line shows the position of the lock lever 340, while the locking feature 309 is being docked into or undocked from the locking groove 334, referred as position B, indicating the docking and/or undocking state.

The link lever 350 is connected through a gear pin 364 to the first gearing unit 362. A gear slot 352 is provided on the link lever 350 to accommodate the gear pin 364. The link lever 350 indicated by dotted lines indicates the position of the link lever 350 before and after locking the locking feature 309 to the locking groove 334. The link lever 350 indicated by solid line shows the position of the link lever 350, while the locking feature 309 is being docked the locking groove 334. The undocking state the gear pin 364 will be moving in accordance with the gearing unit 360 movement and thus the gear pin 364 is positioned towards the lower end of the gear slot 352. Towards the end of the docking state, the gear pin 364 will be positioned towards the upper end of the gear slot 352. While docking, the gear pin 364 will not be moving and the lock lever 340 moves to position the gear pin 364 towards toe upper end of the gear slot 352.

The gearing assembly 360 does not have any change in its position in the docked/undocked and docking state. The gearing assembly 360 will be rotating only while undocking the locking feature. The torsion spring 369 (not shown) associated with the second gearing unit 365 assists the gearing assembly 360 to retain its original position, once tables are undocked.

The main technical advantages of the invention include docking the table by single person and docking is not dependent on the position of the locking groove. Further undocking of the tables can be done from both side of the table. The workflow for docking and undocking is very simple and the docking mechanism is very simple.

In the proposed docking assembly, the default condition of the lock lever 340 is closed. The lock lever 340 is able to accept and lock the locking feature 309 and this is not position dependant of the lock lever 340. The rotating knob of the surgical suite does not rotate while docking and after undocking it reach again in the default condition.

As used herein, an element or step recited in the singular and proceeded with the word “a” or “an” should be understood as not excluding plural elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Exemplary embodiments are described above in detail. The assemblies and methods are not limited to the specific embodiments described herein, but rather, components of each assembly and/or method may be utilized independently and separately from other components described herein. For example in place of rotating knob, motor driven shaft with limit switch can be used and pulley may be used in place of rotating shaft. Similarly rotating knob can be replaced by link mechanism to rotate rotating shaft. In place of two gearing units in the gearing assembly, timing belt can be used and gearing units can be replaced with chain mechanism. Further the steps involved in the workflow need not follow the sequence in which there are illustrated in figures and all the steps in the work flow need not be performed necessarily to complete the method.

While the invention has been described with reference to preferred embodiments, those skilled in the art will appreciate that certain substitutions, alterations and omissions may be made to the embodiments without departing from the spirit of the invention. Accordingly, the foregoing description is meant to be exemplary only, and should not limit the scope of the invention as set forth in the following claims.

We claim:

1. A docking mechanism attachable to a first table capable of docking the first table with a second table through at least one locking feature associated with the second table comprises:
a tapering receiving chamber having a locking groove for receiving the locking feature from the second table;
a lock lever located adjacent to the locking groove, the lock lever being moved to dock the tables;
a link lever attached to a lock lever, the link lever being rotated through the lock lever to dock the locking feature with the locking groove;
a gearing assembly associated with the receiving chamber having a first gearing unit linked with a second gearing unit; first gearing unit being connected to the link lever;
wherein the link lever rotates without rotating the first gearing unit while docking the tables and the lock lever rotates through the first and second gearing unit to undock the patient tables.

2. The docking mechanism as claimed in claim 1, wherein a pair of docking mechanism is attached to sides of the second table.

3. The docking mechanism as claimed in claim 1, wherein the second gearing units on the docking mechanism attached to both sides of the second table are connected through a shaft.

4. The system as claimed in claim 1, a gear pin is provided connecting the link lever to the first gearing unit, the link lever being moved with reference to the gear pin without rotating the first gearing unit, while docking.

5. A patient transport system for transferring patient from a first table to a second table comprises:
a docking assembly having at least two docking mechanisms connected via a shaft, each docking mechanism comprises a front portion and a rear portion, wherein the rear portion being attachable to the first table and the front portion capable of being receiving a locking feature from the second table;
the front portion of each docking mechanism comprises:
a tapering receiving chamber having a locking groove capable of receiving locking feature from the second table;
a lock lever placed adjacent to the locking groove, the lock lever being moved to dock the tables;
gearing assembly associated with the receiving chamber having a first gearing unit linked with a second gearing unit; first gearing unit being attached to the link lever; a second gearing unit attached to the shaft; a link lever attached to a lock lever;
the link level connecting the lock lever to the gearing assembly
wherein the link lever rotates without rotating the first gearing unit while docking the tables and lock lever being rotated through the second and first gearing unit to unlock the patient tables.

6. The system as claimed in claim 5, wherein the tapering receiving chamber is configured to guide the locking feature of the second table to the locking groove.

7. The system as claimed in claim 5, wherein the lock lever is provided with a latch placed adjacent to the locking groove, the locking latch is configured to move down upon receiving the locking feature, thereby moving the lock lever and the link lever.

8. The system as claimed in claim 5, further comprises a spring mechanism configured to hinge the lock lever to housing of the docking mechanism.

9. The system as claimed in claim 5, a gear pin is provided on the first gearing unit connecting the link lever to the first gearing unit, the link lever being moved with reference to the gear pin without rotating the first gearing unit, while docking.

10. The system as claimed in claim 5, further comprises a shaft knob on both sides of the docking mechanism configured to rotate the second gear for unlocking the tables.

11. The system as claimed in claim 10, wherein upon rotating the shaft knob the second gearing unit is configured to rotate the first gearing unit along with the gear pin thereby rotating the link lever and lock lever.

12. The system as claimed in claim 5, further comprises a detent on the knob with a chamfered hole on the housing of the docking mechanism to indicate the locking status.

13. The system as claimed in claim 5, further comprises torsion spring attached to the second gearing unit and the housing for retaining knob in the original position.

14. A patient transfer mechanism from a manual patient table to a surgical patient table comprises:
the manual table having at least two locking pins for locking the manual table with the surgical table;
the surgical table having a docking assembly attached to one end of the table, the docking assembly comprises:
a docking assembly having at least two docking mechanisms connected via a shaft, each docking mechanism comprises:
a tapering receiving chamber having a locking groove capable of receiving locking pins from the manual table;
a lock lever placed adjacent to the locking groove, the lock lever being moved to dock the tables;
a link level attached to a lock lever, the link level being rotated through the lock lever to dock the locking feature with the locking groove;
gearing assembly associated with the receiving chamber having a first gearing unit linked with a second gearing unit; first gearing unit being attached to the link lever; a second gearing unit attached to the shaft;
wherein the docking assembly attached to the surgical table is configured to receive the locking pins from the manual table and automatically locks the pins to the locking groove and releases the locking pins upon manually rotating the knob.

15. The mechanism as claimed in claim 14, wherein each docking mechanism is attached to sides of the surgical table, the surgical table being provided with fixing slot to attach the docking mechanism.

16. The mechanism as claimed in claim 14, wherein the docking mechanism is provided with plurality of fixing slots to adjust the height and width of the docking mechanism.

17. The mechanism as claimed in claim 14, wherein the lock lever is provided with a locking latch placed adjacent to the locking groove, the locking latch is configured to move down upon receiving the locking feature, thereby moving the lock lever and the link lever.

18. The mechanism as claimed in claim 14, further comprises a spring mechanism hinging the lock lever to housing of the docking mechanism.

19. The mechanism as claimed in claim 14 wherein a gear pin is provided connecting the link lever to the first gearing unit, link lever being moved with reference to the gear pin without rotating the first gearing unit.
